(19) United States
(12) Patent Application Publication
(10) Pub. No.: US 2002/0159256 A1
(43) Pub. Date: Oct. 31, 2002

(54) Detachable christmas ornamental ball

(76) Inventor: Ming-Hsiung Chen, Taipei City (TW)

Correspondence Address: Richard P. Berg, Ladas & Parry, Suite #2100, 5670 Wilshire Boulevard, Los Angeles, CA, 90036-5679, US

(21) Appl. No.: 09/843,084

(22) Filed: Apr. 25, 2001

(51) Int. Cl. F21V 3/00; F21S 4/00

(52) U.S. Cl. 362/226; 362/235; 362/806

(57) ABSTRACT

A detachable Christmas ornamental ball includes a light penetrable spherical shell having an opening, and a cap-like top cover detachably fastened to the opening of the spherical shell to hold at least one lamp socket and a lamp bulb on each lamp socket in the spherical shell, the top cover having a peripheral wall defining a bottom open chamber, two springy hook plates formed integral with the peripheral wall at two opposite sides and respectively hooked on the periphery of the opening of the spherical shell to secure the top cover to the spherical shell, a plurality of splits cut through the peripheral wall at two opposite lateral sides of each of the springy hook plates, and two springy oblique retaining plates suspended in the bottom open chamber and adapted to hold at least one lamp socket in the spherical shell. Squeezing the springy hook plates of the top cover inwards with the fingers enables the top cover with the attached at least one lamp socket to be removed from the spherical shell for a maintenance work.

### BACKGROUND OF THE INVENTION

The present invention relates to lamps and, more particularly, to a detachable Christmas ornamental ball, which comprises a spherical shell, a top cover detachably hooked on an opening of the spherical shell to hold at least one mini lamp socket in the spherical shell and a lamp bulb in each mini lamp socket inside the center position of the spherical shell.

In addition to Christmas tree light strings, decorative balls B of different colors and designs may be used to decorate Christmas trees (see FIG. 1). These decorative balls B commonly have a diameter at about 6˜10 cm, and an outside wall electroplated with a color coating of a particular design. Because these decorative balls B are not designed to hold a lamp bulb on the inside, the design of these decorative balls B are indicative only illuminated by external light source. Further, there is known Christmas ornamental devices A designed for attaching to each mini lamp of decorative light strings. When a mini lamp of a light string is inserted into the top fixing hole of a Christmas ornamental device A, the high positioned light of the mini lamp is not with sufficient illumination to evenly distribute through the peripheral wall of the Christmas ornamental device A, and the whole design of the Christmas ornamental device A is not easy to see. As illustrated in FIG. 1, the highlighted circular area A1 is the illuminated area, the other area of the Christmas ornamental devices A is the dark area not well illuminated.

### SUMMARY OF THE INVENTION

It is one object of the present invention to provide a detachable Christmas ornamental ball, which has a detachable top cover detachably adapted to hold at least one mini lamp socket and a lamp bulb in each mini lamp socket in a spherical shell. It is another object of the present invention to provide a detachable Christmas ornamental ball, which is printed with various designs on the peripheral wall and, has a diameter about 6˜10 cm adapted to receive at least one mini lamp on the inside center position, so that sufficient illumination can be evenly provided on the inside, enabling the designs of the ornamental ball to be well seen. To achieve these and other objects of the present invention, the detachable Christmas ornamental ball comprises a light penetrable spherical shell having an opening, and a cap-like top cover detachably fastened to the opening of the spherical shell to hold at least one mini lamp socket and a lamp bulb on each mini lamp socket in the spherical shell. The top cover has a peripheral wall defining a bottom open chamber, two springy hook plates formed integral with the peripheral wall at two opposite sides and respectively hooked on the periphery of the opening of the spherical shell to secure the top cover to the spherical shell, a plurality of splits cut through the peripheral wall at two opposite lateral sides of each of the springy hook plates for enhance the spring power of the springy hook plates, and two springy oblique retaining plates suspended in the bottom open chamber and adapted to hold at least one mini lamp socket in the spherical shell. By means of squeezing the hook plates of the top cover inwards, the top cover and the attached at least one mini lamp socket with the related lamp bulb can easily be removed from the spherical shell for a maintenance work.

### BRIEF DESCRIPTION OF THE DRAWINGS

FIG. 1 illustrates lighted ornamental devices and decorative balls installed in a Christmas tree according to the prior art.

FIG. 2A is an exploded view of a detachable Christmas ornamental ball used with two lamp sockets according to the present invention.

FIG. 2B is an assembly view of FIG. 2A.

FIG. 2C is a sectional plain view of the detachable Christmas ornamental ball shown in FIG. 2B.

FIG. 3A is an exploded view of a detachable Christmas ornamental ball used with one lamp socket according to the present invention.

FIG. 3B is an assembly view of FIG. 3A.

FIG. 3C is a sectional plain view of the detachable Christmas ornamental ball shown in FIG. 3B.

FIG. 4A is a cross-sectional view in an enlarged scale of the top cover of the detachable Christmas ornamental ball shown in FIG. 2A.

FIG. 4B is a cross-sectional view in an enlarged scale of the top cover of the detachable Christmas ornamental ball shown in FIG. 3A.

FIG. 5 is a sectional side view of the top cover for the detachable Christmas ornamental ball according to the present invention.

FIG. 6A is a sectional plain view showing the lamp socket aimed at the bottom open chamber of the top cover according to the present invention.

FIG. 6B is a sectional plain view showing the topside of the lamp socket stopped against the bottom ends of the springy oblique retaining plates of the top cover according to the present invention.

FIG. 6C is a sectional plain view showing the lamp socket inserted into the holding space between the springy oblique retaining plates of the top cover, the springy oblique retaining plates of the top cover clamped on the lamp socket according to the present invention.

FIG. 7A is a sectional plain view showing the hook plates of the top cover aimed at the opening of the spherical shell according to the present invention.

FIG. 7B is a sectional plain view showing the sloping bottom edge of each of the hook plates of the top cover respectively stopped against the peripheral edge of the opening of the spherical shell according to the present invention.

FIG. 7C is a sectional plain view showing the hooked bottom retaining flange of each of the hook plates of the top cover hooked on the peripheral edge of the opening of the spherical shell according to the present invention.

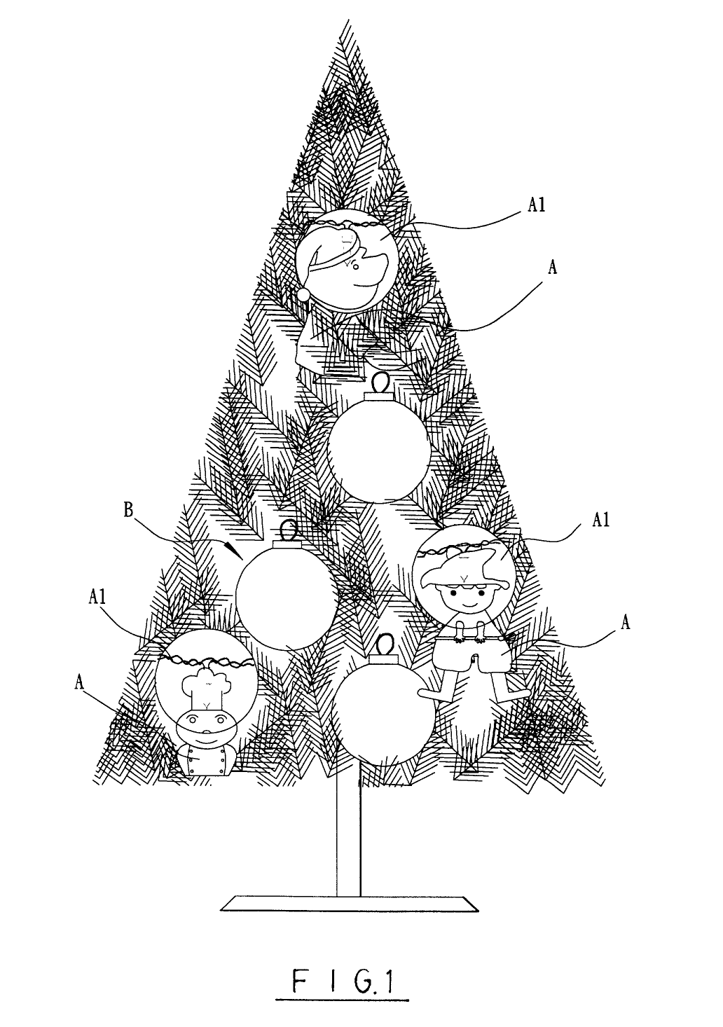

### DETAILED DESCRIPTION OF THE PREFERRED EMBODIMENT

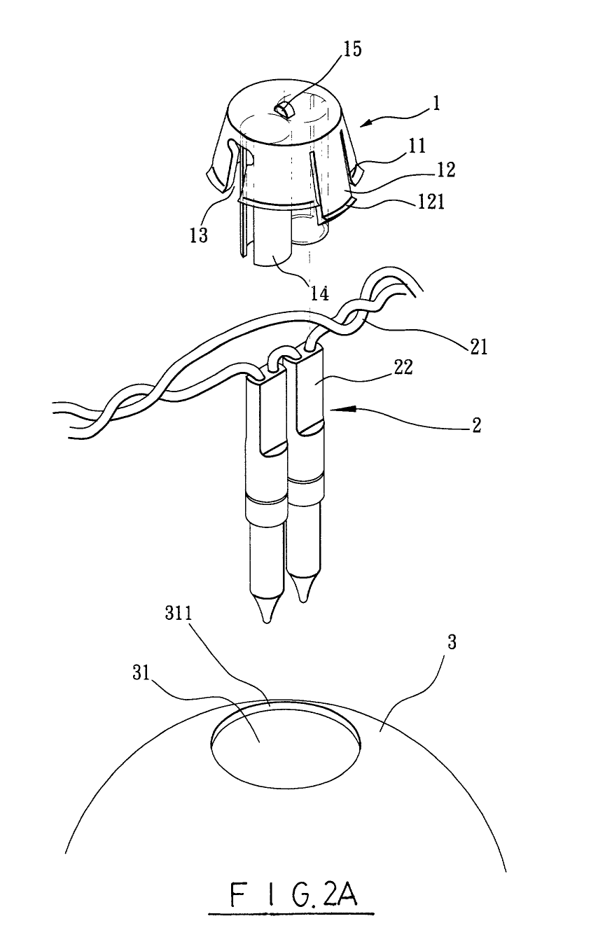

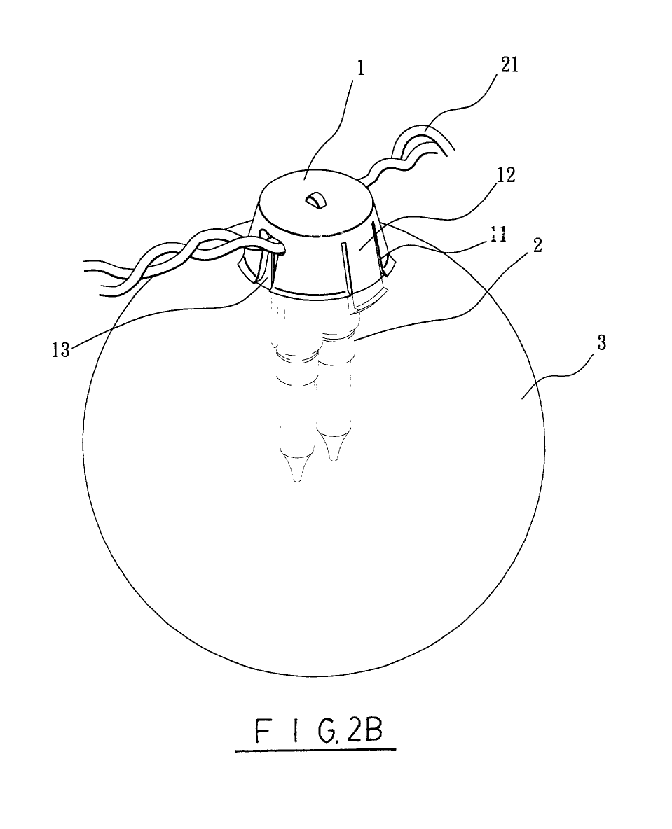

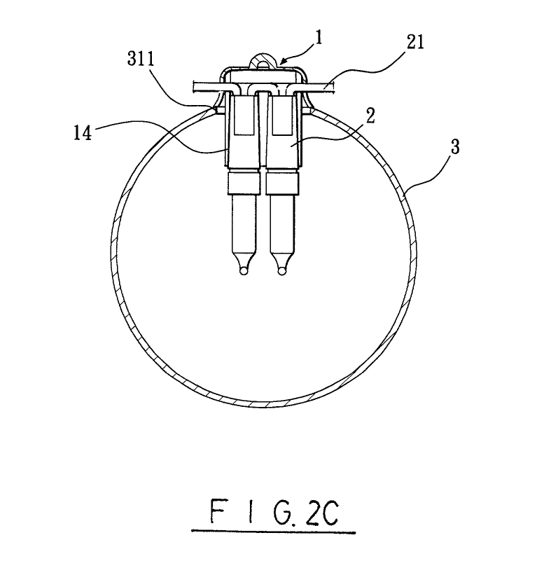

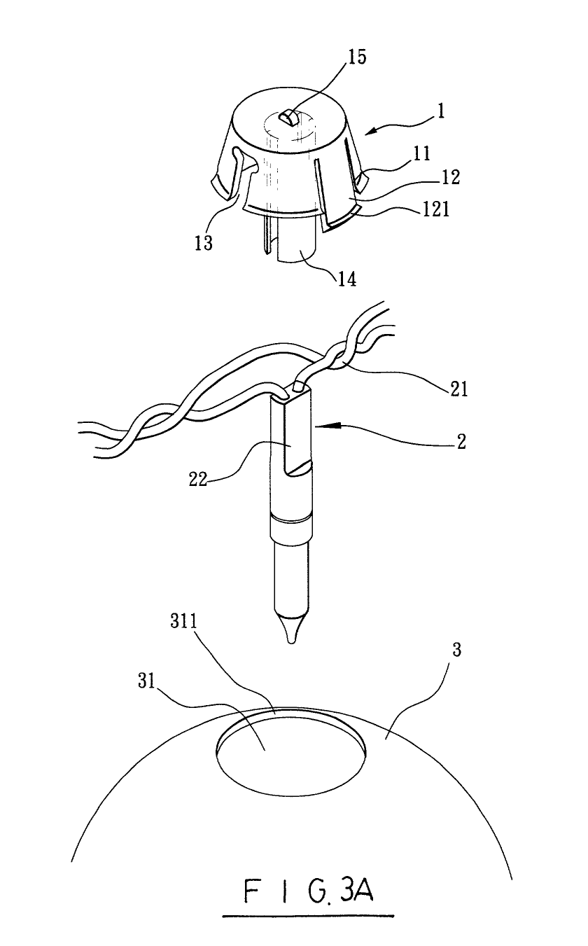

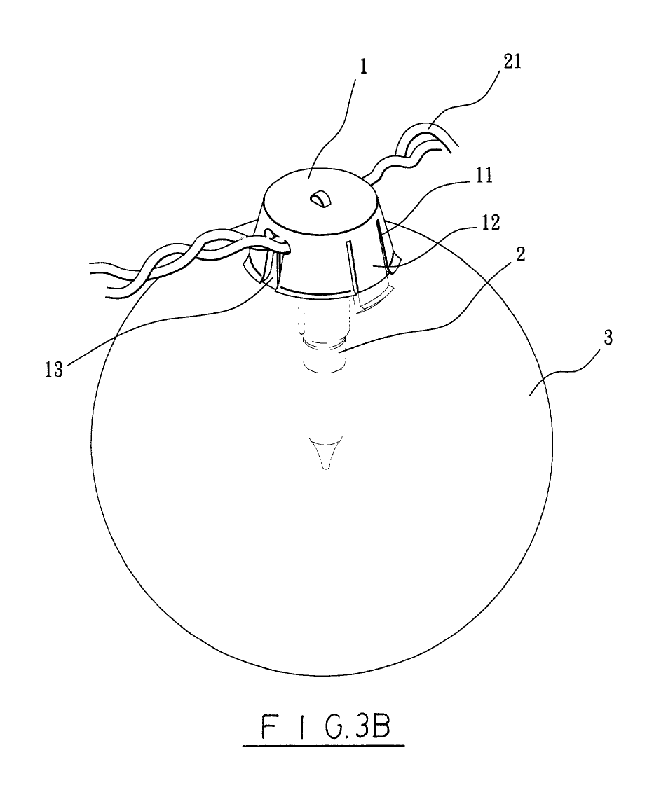

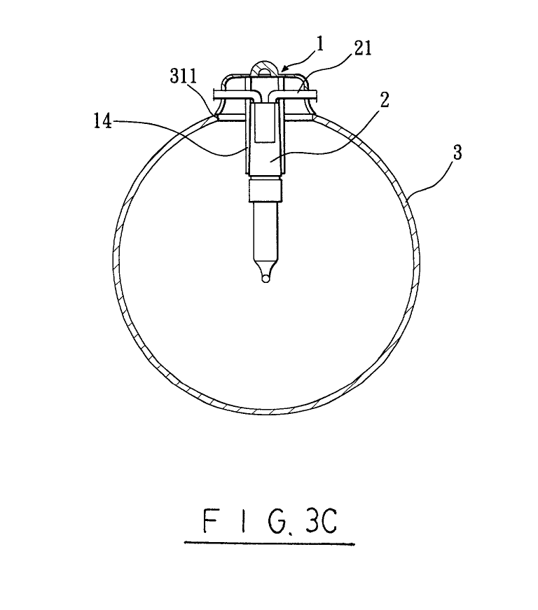

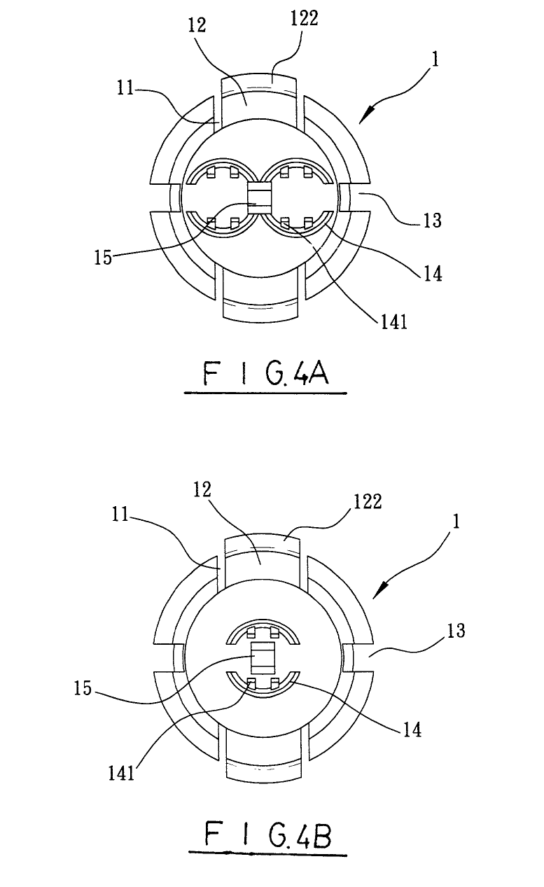

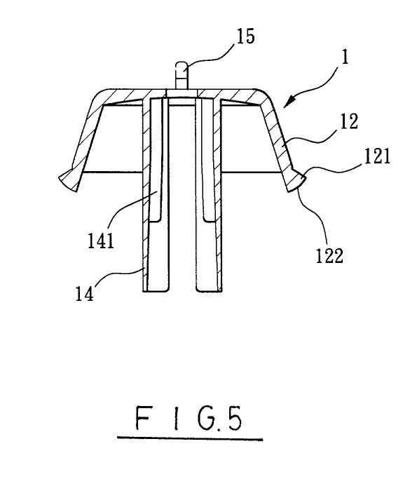

Referring to FIGS. from 2 through 5, a detachable Christmas ornamental ball is designed for use with a decorative light string to decorate a Christmas tree or the like, comprising a top cover 1, and a spherical shell 3. The top cover 1 is made of springy material (for example, thin metal sheet, plastics, or the like). According to the present preferred embodiment, the top cover 1 is shaped like a cylindrical cap having a peripheral wall that defines a bottom open chamber. Two springy hook plates 12 are formed integral with the peripheral wall of the top cover 1 at two opposite sides. Two springy oblique retaining plates 14 are downwardly extended from the top inside wall of the top cover 1 and suspended in the bottom open chamber of the top cover 1 between the hook plates 12. Two peripheral openings 13 are disposed at two opposite sides and respectively equally spaced between the hook plates 12. The hook plates 12 are formed of the peripheral wall of the top cover 1, each having two lateral sides separated from the peripheral wall of the top cover 1 by splits 11, and a hooked bottom retaining flange 121. Because of the design of the splits 11, the hook plates 12 have a long arm of force and high spring power. The hooked bottom retaining flange 121 has a downwardly inwardly extended sloping bottom edge 122. The downwardly suspended oblique retaining plates 14 define a holding space adapted to hold at least one lamp socket 2. The retaining plates 14 can be made having an arched cross section adapted to hold one lamp socket 2 as shown in FIGS. 3A and 4B, or double-arched cross section adapted to hold two lamp sockets 2 as shown in FIGS. 2A and 4A. Each retaining plate 14 further comprises a plurality of stop blocks 141 symmetrically raised from the respective inner surface (see FIGS. 4A, 4B, and. 5). The peripheral openings 13 of the top cover 1 are adapted to receive the electric wires 21 of the lamp socket(s) 2. Further, an eyelet 15 is provided at the top sidewall of the top cover 1 on the outside for hanging. The spherical shell 3 has an opening 31. Through the opening 31, the lamp socket 2 and the bulb on the lamp socket 2 are inserted into the inside of the spherical shell 3. The inside wall as well as the outside wall of the spherical shell 3 may be coated with a layer of light-penetrable color coating, or painted with a particular design.

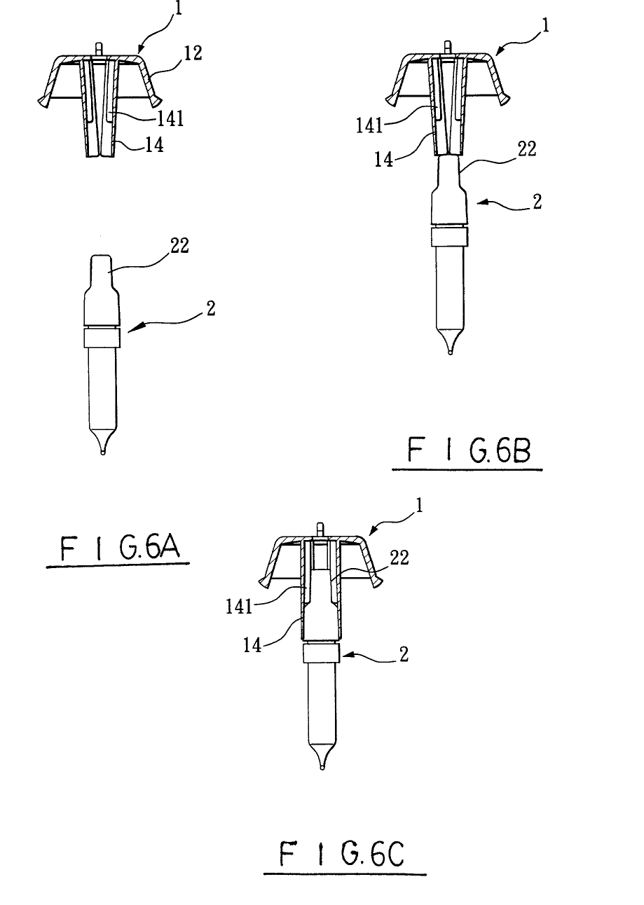

The assembly of the top cover 1 and the lamp socket 2 is described hereinafter with reference to FIGS. from 6A through 6C. The topside of the lamp socket 2 is aimed at the bottom open chamber of the top cover 1 (see FIG. 6A), and then the topside of the lamp socket 2 is stopped against the bottom ends of the springy oblique retaining plates 14 of the top cover 1 (see FIG. 6B) and forced into the holding space between the retaining plates 14 of the top cover 1 (see FIG. 6C). When inserting the lamp socket 2 into the holding space between the retaining plates 14 of the top cover 1, the retaining plates 14 are deformed and respectively forced outwards. After the lamp socket 2 has been set into position, the retaining plates 14 immediately return to their former shape and clamped on the periphery of the lamp socket 2 to hold down the lamp socket 2 in the top cover 1, and the stop blocks 141 of the retaining plates 14 are respectively engaged into the two opposite planes 22 of the socket 2 to stop the socket 2 in position (see FIG. 6C), preventing the socket 2 from being inserted into the inside of the top cover plate 1 excessively. When assembled, the electric wires 21 of lamp socket 2 are extended through the peripheral openings 13 of the top cover 1 (see FIGS. 2B, 2C, 3B, 3C), and kept in place.

After the assembly of the top cover 1 with the lamp socket 2, the top cover 1 is fastened to the peripheral edge 311 of the opening 31 of the spherical shell 3 to hold the lamp socket 2 and the related lamp bulb inside the spherical shell 3

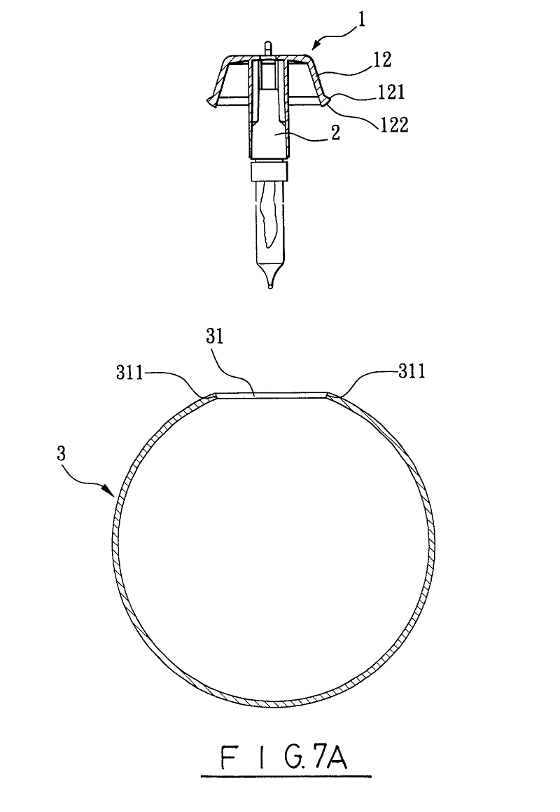

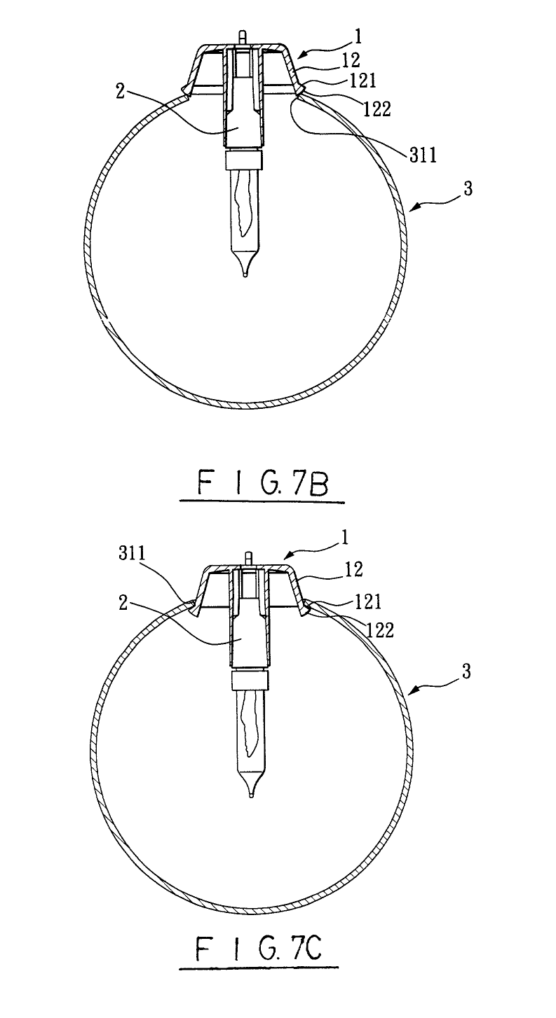

The assembly of the top cover 1 and the spherical shell 3 is described hereinafter with reference to FIGS. from 7A through 7C. The hook plates 12 of the top cover 1 are aimed at the opening 31 of the spherical shell 3 (see FIG. 6A), and then the hook plates 12 are squeezed inwards and inserted into the opening 31 of the spherical shell 3. At the initial stage when inserting the hook plates 12 into the opening 31 of the spherical shell 3, the sloping bottom edge 122 of the hooked bottom retaining flange 121 of each of the hook plates 12 is respectively stopped against the peripheral edge 311 of the opening 31 of the spherical shell 3 (see FIG. 7B). Because the sloping bottom edge 122 of the hooked bottom retaining flange 121 of each of the hook plates 12 of the top cover 1 slopes downwardly inwards, the hook plates 12 can easily be inserted into the opening 31 of the spherical shell 3. After the sloping bottom edge 122 of the hooked bottom retaining flange 121 of each of the hook plates 12 of the top cover 1 passed over the peripheral edge 311 of the opening 31 of the spherical shell 3, the material spring power of the hook plates 12 immediately forces the hooked bottom retaining flange 121 of each of the hook plates 12 of the top cover 1 into engagement with the peripheral edge 311 of the opening 31 of the spherical shell 3 (see FIG. 7C). Thus, the top cover 1 is fastened to the spherical shell 3 to hold the lamp socket(s) 2 and the lamp bulb(s) inside the center position of the spherical shell 3 (see FIG. 7C). According to the present preferred embodiment, the spherical shell 3 can have a diameter at about 6˜10 cm. When connecting electricity to the lamp socket(s) 2 through the electric wires 21, the lamp bulb of each lamp socket 2 is driven to emit light through the spherical shell 3 and to evenly illuminate the various designs painted on the detachable Christmas ornamental ball.

In case the lamp bulb is damaged, the top cover 1 and the lamp socket(s) 2 can easily be removed from the spherical shell 3. When squeezing the hook plates 12 inwards with two fingers, the hooked bottom retaining flange 121 of each of the hook plates 12 is respectively disengaged from the peripheral edge 311 of the opening 31 of the spherical shell 3, enabling the top cover 1 and the lamp socket(s) 2 to be separated from the spherical shell 3. After replacement of the damaged lamp bulb, the top cover 2 is fastened to the peripheral edge 311 of the opening 31 of the spherical shell 3 to hold the lamp socket(s) 2 and the new lamp bulb(s) inside the center position of the spherical shell 3.

A prototype of detachable Christmas ornamental ball has been constructed with the features of FIGS. 2˜7. The detachable Christmas ornamental ball functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A detachable Christmas ornamental ball comprising:
a spherical shell that admits light, said spherical shell having an opening; and
a top cover fastened to the opening of said spherical shell to hold at least one lamp socket and a lamp bulb in each of the at least one lamp socket in said spherical shell, said top cover comprising a peripheral wall defining a bottom open chamber, two springy hook plates formed integral with said peripheral wall at two opposite sides and respectively hooked on the periphery of said opening of said spherical shell to secure said top cover to said spherical shell, a plurality of splits cut through said peripheral wall at two opposite lateral sides of each of said springy hook plates, two peripheral openings, and two springy oblique retaining plates suspended in said bottom open chamber between said hook plates and adapted to hold at least one lamp socket in said spherical shell.

2. The detachable Christmas ornamental ball of claim 1 wherein said two peripheral openings of said top cover are disposed at two opposite sides and adapted to hold electric wires of the at least one lamp socket being fastened to said top cover.

3. The detachable Christmas ornamental ball of claim 1 wherein said hook plates of said top cover each comprise a hooked bottom retaining flange adapted to hook on the periphery of the opening of said spherical shell.

4. The detachable Christmas ornamental ball of claim 1 wherein said springy oblique retaining plates are downwardly inwardly extended from the top inside wall of said top cover toward the center of said bottom open chamber, said springy oblique retaining plates each having a plurality of stop blocks raised from a respective inner surface and adapted to stop the inserted at least one lamp socket in place and a curved cross section fitting the periphery of the at least one lamp socket being inserted into said top cover.
